(19) United States
(12) Patent Application Publication
(10) Pub. No.: US 2020/0279206 A1
(43) Pub. Date: Sep. 3, 2020

(54) SYSTEMS AND METHODS FOR PROVISIONING AND TRACKING TELECOMMUNICATIONS PROJECTS

(71) Applicant: Level 3 Communications, LLC, Broomfield, CO (US)

(72) Inventors: Masum C. Muttalib, Denver, CO (US); Kristen E. Hirsch, Arvada, CO (US); Daniel Tagart, Broomfield, CO (US); Cynthia Richey, Denver, CO (US)

(21) Appl. No.: 16/797,721

(22) Filed: Feb. 21, 2020

Related U.S. Application Data
(60) Provisional application No. 62/811,643, filed on Feb. 28, 2019.

(51) Int. Cl. G06Q 10/06; G06Q 10/10; G06Q 50/30; G06F 3/0482; G06F 3/0481

(52) U.S. Cl. CPC G06Q 10/063114; G06Q 10/109; G06F 3/04817; G06F 3/0482; G06Q 50/30

(57) ABSTRACT

The present disclosure describes systems, methods, and non-transitory computer readable media for determining project lifecycles and tracking opportunities in the telecommunications sphere. These systems, methods, and non-transitory computer readable media can access information for a project offering, receive input to modify the project offering's information, update the project offering information, generate deadlines or reminders for the project offering, and generate a display of the project offering's lifecycle track.

### CROSS-REFERENCE TO RELATED APPLICATION

This application is related to and claims priority under 35 U.S.C. § 119(e) from U.S. Patent Application No. 62/811,643, filed Feb. 28, 2019 entitled “Project Monitoring Systems and Methods,” the entire contents of which is incorporated herein by reference for all purposes.

### TECHNICAL FIELD

Embodiments of the present invention generally relate to systems and methods for monitoring and predicting telecommunication projects.

### BACKGROUND

Modern telecommunication projects require high levels of coordination, management, and logistical planning. Multiple project lifecycles encompass a panoply of moving parts, including contracts and sub-projects, not to mention ongoing possibilities for new telecommunication projects. Properly monitoring and predicting the course of telecommunication projects is a necessary component of modern operations.

It is with these observations in mind, among others, that the various aspects of the present disclosure were conceived.

### SUMMARY

The present disclosure describes systems, methods, and non-transitory computer readable media for determining opportunities and tracking a project lifecycle. Specifically, the present disclosure concerns itself with these systems, methods, and non-transitory computer readable media in the context of telecommunications projects.

A system can include one or more processors and a memory storing instructions that, when executed by the one or more processors, cause the one or more processors to access information for a project offering, the information comprising a customer identification and network service capability; receive input to modify the information for the project offering; update the information for the project offering according to the input; generate, based on the updated information, one of a deadline or a reminder associated with the project offering; and generate, for display, a lifecycle track of the project offering, the lifecycle track comprising a visual progression of the information based in part on one of the deadline or the reminder.

A method can include accessing information for a project offering, the information comprising a customer identification and network service capability; receiving input to modify the information for the project offering; updating the information for the project offering according to the input; generating, based on the updated information, one of a deadline or a reminder associated with the project offering; and generating, for display, a lifecycle track of the project offering, the lifecycle track comprising a visual progression of the information based in part on one of the deadline or the reminder.

A non-transitory computer readable medium can include instructions stored thereon, the instructions effective to cause one or more processors to access information for a project offering, the information comprising a customer identification and network service capability; receive input to modify the information for the project offering; update the information for the project offering according to the input; generate, based on the updated information, one of a deadline or a reminder associated with the project offering; and generate, for display, a lifecycle track of the project offering, the lifecycle track comprising a visual progression of the information based in part on one of the deadline or the reminder.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 is a diagram of an example system for tracking project lifecycles and opportunities, in accordance with the subject technology;

FIG. 2 is a diagram of an example management view interface, in accordance with the subject technology;

FIG. 3 is a diagram of an example opportunities view interface, in accordance with the subject technology;

FIG. 4 is a diagram of an example opportunities view interface for a selected account, in accordance with the subject technology;

FIG. 5 is a diagram of an example milestones tracker form interface, in accordance with the subject technology; and

FIG. 6 is a diagram illustrating an example of a computing system which may be used in implementing embodiments of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Aspects of the present disclosure involve systems, methods, and the like for identifying opportunities in and tracking projects through a sales cycle. For example, in the telecommunications industry, projects (e.g., for provisioning a service, etc.) are often manually tracked, or not systematically tracked at all, and so a myriad of opportunities for the sale of new or expanded services may be lost. Aspects of the present disclosure may enable automated tracking and identification of opportunities for additional services to be offered along with a project that is being provisioned (or negotiated) by providing an application-driven process flow and alerting system. Project timings (e.g., due to an elapsed period of time since an earlier proposal or based on changes in costs, etc.) for proposing projects to customers are also determined based on initial, ongoing, and derived inputs generated by, and received in part through, a web application interface.

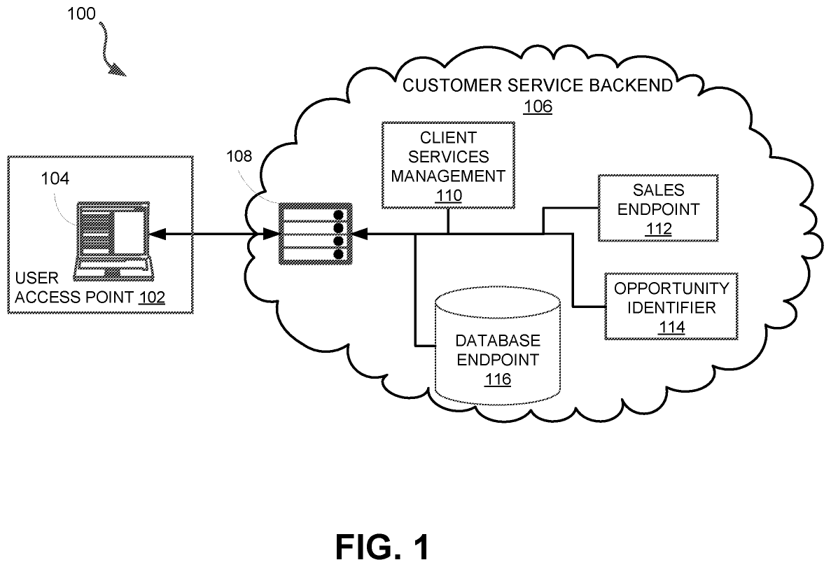

FIG. 1 is a diagram of a project opportunities and lifecycle tracking system 100. In general, system 100 may enable opportunities for project contracts with new or existing customers, such as installing a new network connection or converting a potential customer who is off network (e.g., receives service from another a third-party provider) to an on-network connection (e.g., in order to receive service through a user of system 100, etc.).

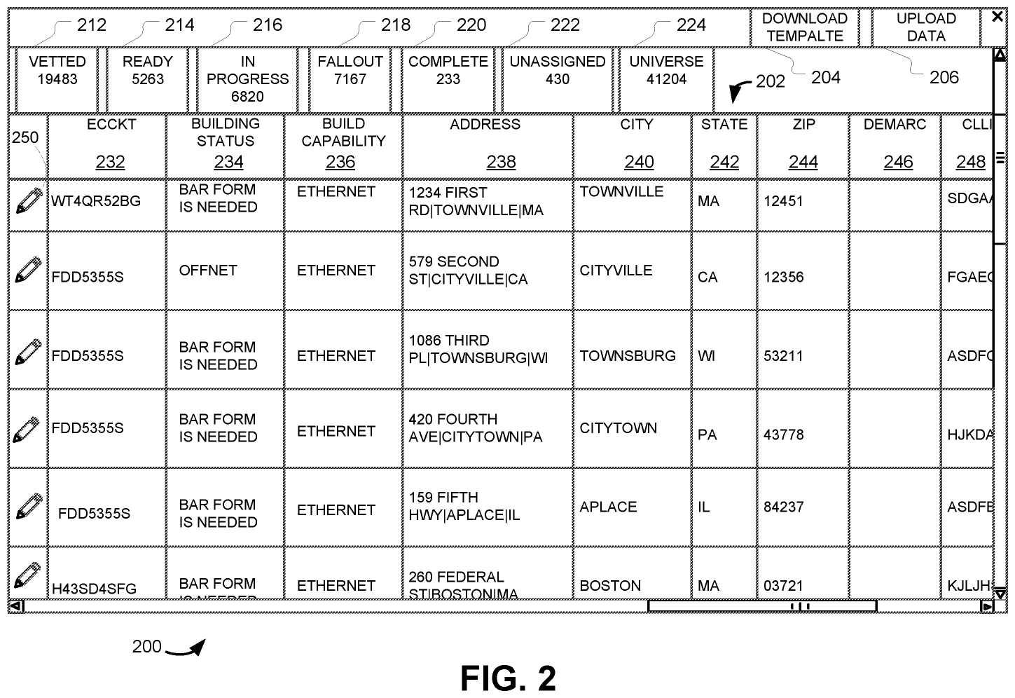

System 100 includes a user access point 102, in some examples a computing device 104 such as a personal computer, laptop, mobile device, etc., in communication with a customer service backend 106. User access point 102 may connect to customer service backend 106 via a public network connection (e.g., the Internet) or over a private network such as, for example and without imputing limitation, an intranet, local area network (LAN), virtual private network (VPN), and the like. Nevertheless, user access point 102 can communicate with customer service backend 106 through a receiving server 108, which itself may either include various backend services or be in communication with services over a networked connection for generating a user interface (discussed in FIGS. 2-5 below) according to user activity on user access point 102. A user may be an employee of a telecommunications company, a contractor, or another party with a vested interest in the tracking and progress of one or more telecommunications projects.

Customer service backend 106 includes a client services management service 110, a sales endpoint 112, an opportunity identifier service 114, and can include a variety of database endpoints 116 as will be apparent to a person having ordinary skill in the art. Database endpoint 116 may include one or more datasets such as customer information, sales representative information and/or history, network information, scheduling information, etc. Server 108 can, based on its own schedule or in response to a request from user access point 102, make queries and the like on database endpoint 116 to, for example, retrieve historical data, contact information, network information, and the like for a user.

Client services management 110 may provide client information to server 108 (e.g., to respond to a request from user access point 102, etc.) and/or may initiate a service event such as an installation, service call, etc. prompted by a user interacting with server 108 via user access point 102. Sales endpoint 112 can include direct sales integration for retrieving and/or updating records related to a particular customer (e.g., negotiation history, etc.). Opportunity identifier 114 can identify and provide to server 108 opportunities for selling a project to a customer based on, for example and without imputing limitation, local (to the customer) environment network changes, pricing adjustments, new service offerings, and the like.

The disclosure now turns to FIGS. 2-5. In general, FIGS. 2-5 depict example user interfaces which may be rendered by, for example, computing device 104 and enable a user to efficiently review a project a lifecycle, to identify project opportunities, and/or interact with a project and/or project record for a customer.

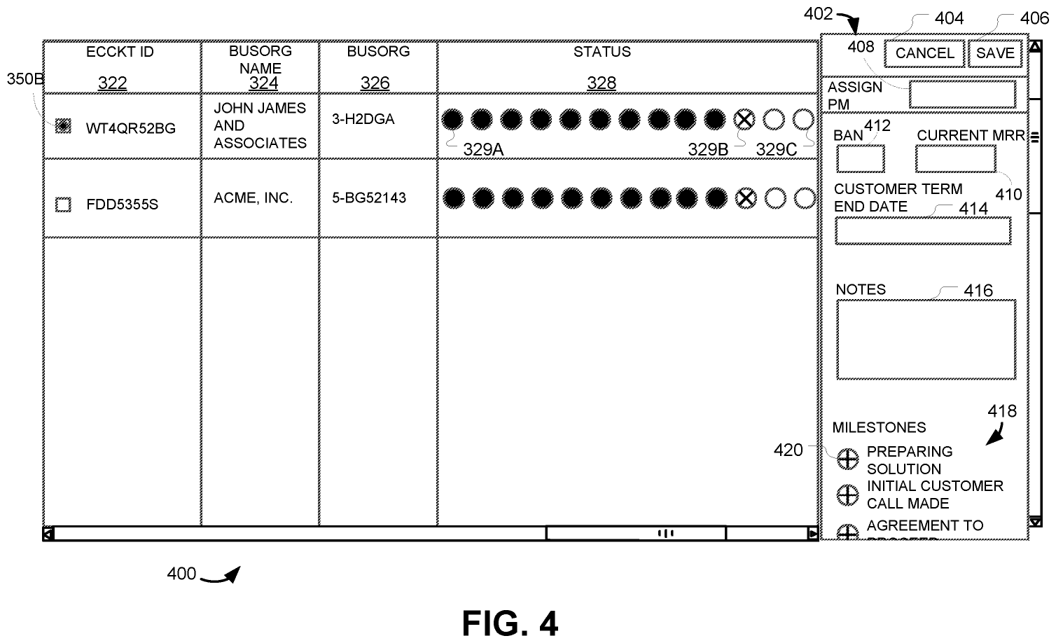

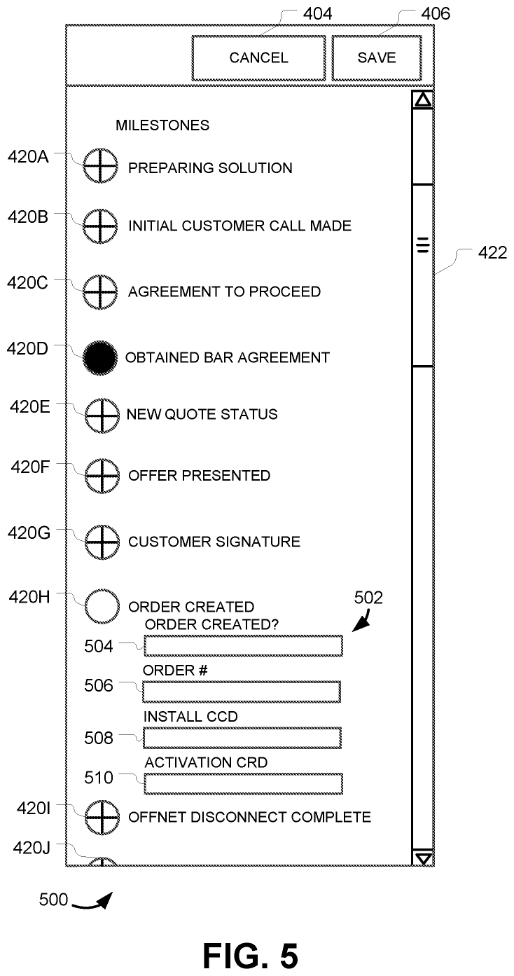

FIG. 2 depicts a management dashboard interface 200. From management dashboard interface 200, a user can find and enter information into a customer record in order to, for example, update a customer-focused form for initiating projects and the like (discussed in FIGS. 4-5 below). In some examples, server 108 may generate interface 200 for display on computing device 104 by automatically accessing services and databases in customer service backend 106. In some examples, data may be uploaded to server 108 for generating interface 200 in the form of, without imputing limitation, a CSV (“comma separated values”) document such as a spreadsheet or the like.

In particular, management dashboard interface 200 includes a plurality of tabs 212-224 through which a user may navigate between differently categorized listings of customer accounts. Each tab displays what information is held under the tab (vetted accounts, accounts ready for service charges, etc.) as well as the number of entries under that tab. As depicted in FIG. 2, management dashboard interface 200 displays account listings on vetted tab 212. Vetted accounts may be accounts associated with customers identified (e.g., by opportunity identifier service 114) as being “off-net” at “on-net” locations. “Off-net” describes locations or customers who, for example, receive network service from a provider not associated with the user. In comparison, “on-net” refers to a customer or location that has available service offerings (e.g., from, or associated with, the user). In effect, accounts displayed on vetted tab 212 may be transitioned to service offerings which the user can provide.

Each tab 212-224, including vetted tab 212, displays a series of account entries 202 in the form of rows. In addition, each tab 212-224 includes a tab type identifier (e.g., “vetted”, “ready”, “in progress”, etc.) and a count of how many account entries are grouped under that tab. Each account (e.g., row) of account entries 202 includes an edit icon 250 to enter or update respective account information. Further, each account row can include, in sequence, an ECCKT (Exchange Company Circuit) identifier 232, building status 234, build capability 236, address 238, city 240, state 242, ZIP code 244, demarcation 246, and CLLI 248. In some examples, customer and/or business organization name, business organization identifier, and other information may be included as well. ECCKT identifier 232 may refer to an industry specific identification of the account and can be used to associate the account with a sales agent, account manager, etc. as will be apparent to a person having ordinary skill in the art. Additionally, customer accounts in vetted tab 212 may be already assigned to an agent, manager, team, etc. In comparison, unassigned tab 222 can provide a view of vetted customer accounts that have yet to be assigned to anyone.

Interacting with ready tab 214 may display a series of account entries that are ready to begin service change procedures. In other words, customers associated with the accounts have entered into an agreement to upgrade, install, or otherwise modify services such as, for example, bringing a service from off-net status to on-net. In progress tab 216 provides a display of a series of account entries that are currently undergoing service upgrades, installations, or other modifications. Fallout tab 218 provides a display of a series of account entries for which service changes or negotiations have ceased before completion for some reason. Completed tab 220 provides a display of a series of account entries for which service changes have been completed. Unassigned tab 222 provides a display of a series of account entries which are vetted (e.g., identified as being off-net but capable of being brought on-net), but not yet assigned to a sales agent, customer service representative, account manager, etc. Universe tab 224 provides a display of all account entries which are displayed in each of the other tabs 212-222, providing a list of projects.

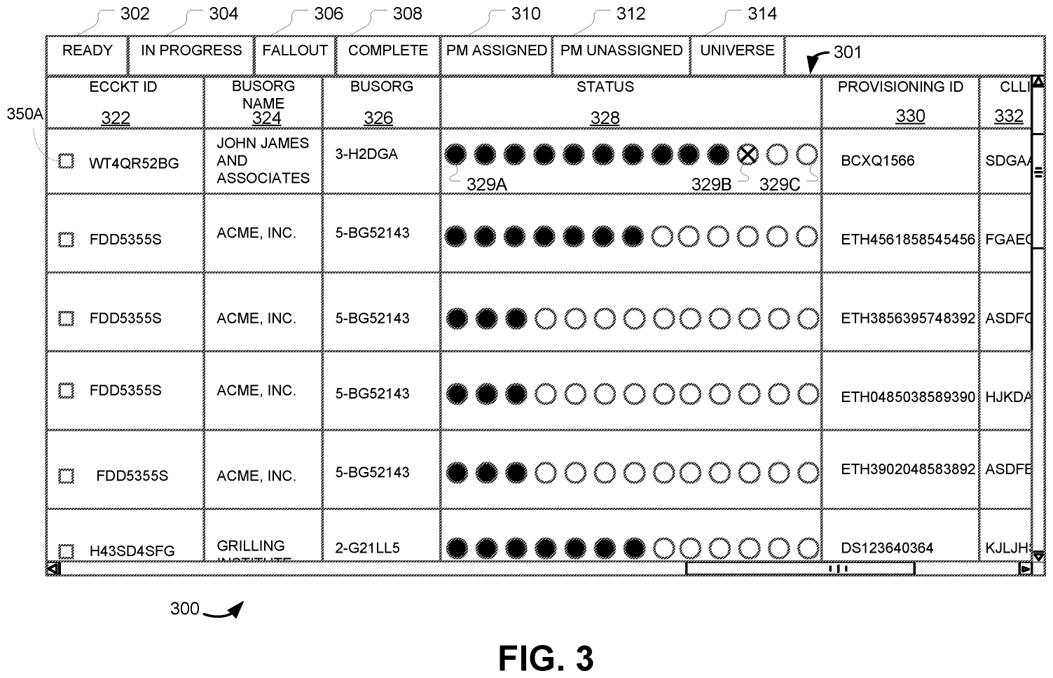

FIG. 3 depicts a customer service management interface 300 from which a user can view filterable account listings to which they may be assigned. For example, an account manager may use customer service management interface 300 to review all customer accounts that have agreed to a service change, are in the process of modifying service, have paused negotiation and/or service modification for some reason, have completed a service change, are assigned to a project manager (PM), are not yet assigned to a PM, and/or are accounts to assigned to the account manager.

Customer service management interface 300 includes a plurality of tabs 302-314 through which a user, such as an account manager for example, can navigate between differently categorized listings of customer accounts to which they are assigned. Each includes an identifier and, as shown in FIG. 3, may include a ready tab 302, an in progress tab 304, a fallout tab 306, a complete tab 308, a PM assigned tab 310, a PM unassigned tab 312, and a universe tab 314.

Each tab 302-314 may provide a display having a series of account entries 301 in the form of rows. Each row may be associated with a unique account as identified by an ECCKT identifier 322. In addition, each unique account may include a business organization name 324, business organization code 326, a status tracker 328, a provisioning identification 330, and a CLLI (Common Language Location Identifier) 332.

Business organization code 326 may provide a unique identification code associated with business organization name 324 for each customer. As a result, different accounts may be associated with identical or substantially similar business organization names 324 and respective business organization codes 326. Provisioning identification 330 can describe a connection type that is available such as, for example, Ethernet, coaxial, direct satellite, and the like.

Status tracker 328 provides an at-a-glance overview of the status of a particular customer account (e.g., ECCKT identifier 322). Status tracker 328 denotes progress of a customer account, or project, across a series of steps with filled in icons 329A denoting step completion and empty icons 329C denoting that a respective step is yet to begin. Current steps that are in progress are denoted by distinct icons 329B which may be distinguished by being partially filled or displayed as entirely different icons from completed icons 329A and not yet started icons 329C (e.g., an “x”, a checkmark, a thumbs up icon, etc.). Further, status tracker 328 may map to a milestone tracker in an expandable form or the like (discussed in FIG. 5 below).

In some cases, a user may need to more deeply examine, update, or modify an account based on, for example, status tracker 328. In such cases, the user can interact with a respective icon 350A associated with each ECCKT identifier 322. Interacting with icon 350A, such as via mouse click and the like, may provide an interface display having a form associated with a respective ECCKT identifier 322, as depicted by FIG. 4.

FIG. 4 depicts a customer account form interface 400 that may be displayed as a result of interacting with icon 350A as described above. Here, ECCKT identifier 322 “WT4QR52BG” is selected and icon 350A changes to filled icon 350B as a result. At the same time, a form 402 is displayed for updating and/or exploring detailed account information for ECCKT identifier 322 WT4QR52BG.

Form 402 can include a plurality of fillable fields for managing and tracking a customer account (e.g., ECCKT identifier 322). In addition, form 402 includes a cancel button 404 and a save button 406 for reverting recent changes made to the form or saving changes, respectively. Saved changes may be uploaded to a database, such as database endpoint 116, and/or percolated out to services within backend system 106 such as, for example, client services management service 110, sales endpoint 112, opportunity identifier service 114, and the like.

In particular, PM field 408 receives a project manager (PM) assignment and/or displays the name of a PM currently assigned to the respective customer account. BAN field 412 and current MRR field 410 may similarly be updated by a user and/or display previously entered information within each respective field. Customer term end date field 414 may denote, and receive as input from the user, an end date related to the respective customer account (e.g., an end date as described in a customer contract, etc.). Additionally, a note field 416 enables the user to review notes from earlier in time and/or input new notes related to the respective customer account that may provide information not otherwise captured by the fillable fields of form 402.

A milestones portion 418 of form 402 includes expandable milestones 420 which map to a respective status tracker 328. In effect, each expandable milestone maps to a respective icon 329A-C and can be interacted with in order to update status tracker 328 or review in more detail individual milestones. Each expandable milestone 420 can include one or more fields, which may be fillable, associated with the respective milestone.

FIG. 5 depicts a milestones portion 500 (e.g., of form 402) including an expanded “order created” milestone 420H which has an expanded milestone menu 502 that may be reviewed and/or edited by a user, such as an account manager and the like. While FIG. 5 depicts only “order created” milestone 420H in an expanded view, milestones portion 500 includes a plurality of milestones mapped to status tracker 328, including, without imputing limitation, “preparing solution” milestone 420A, “initial customer call made” milestone 420B, “agreement to proceed” milestone 420C, “obtained bar agreement” milestone 420D, “new quote status” milestone 420E, “offer presented” milestone 420F, “customer signature” milestone 420G, “offnet disconnect complete” milestone 420I, and additional milestones mapped to status tracker 328, such as milestone 420J, which may be navigated to via scrollbar 422. It is understood that each expandable milestone 420A-J may be expanded to display a respective expanded milestone menu, such as expanded milestone menu 502.

Expanded milestone menu 502 includes a plurality of fields which may be edited by a user as needed. Here, an “order created?” field 504 indicates whether or not an order has been created for the respective customer account, an “order #” field 506 indicates a reference number which may be used to access information for a respective order (e.g., via database endpoint 116 and the like). An “install CCD” field 508 denotes customer comment date information which refers to a date by which a respective customer should provide comment. An “activation CRD” field 510 denotes a customer request date by which time a respective customer has indicated service (e.g., related to the tracked project) is to start. In some examples, such as with expandable milestone 420D, the milestone icon may include distinctive coloring or a different icon than other expandable milestones 420A-J in order to denote that the respective milestone is completed and/or is a binary milestone (e.g., an item, such as a bar agreement, has been obtained and the like).

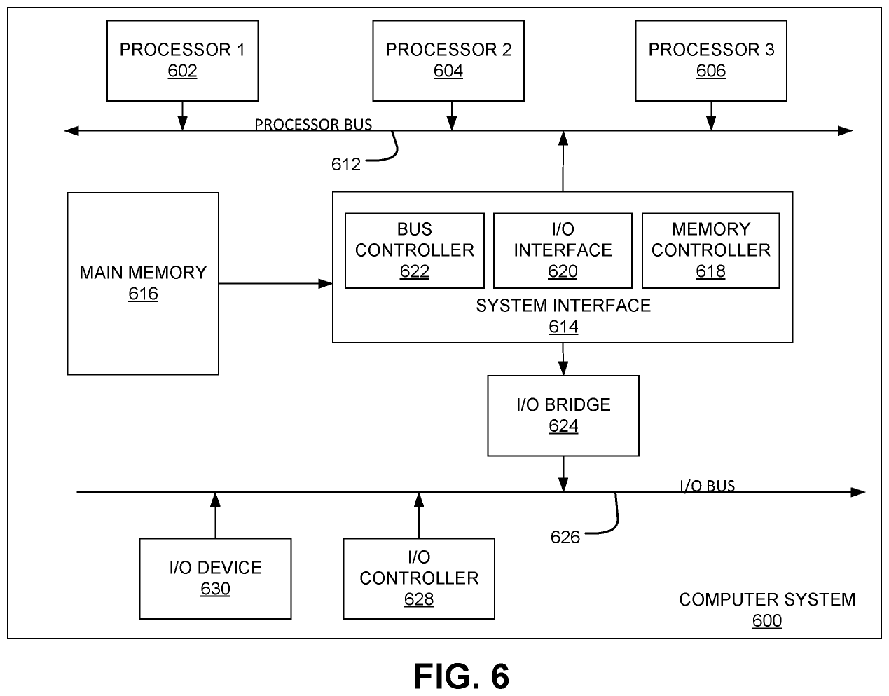

FIG. 6 is a block diagram illustrating an example of a computing device or computer system 600 which may be used in implementing the embodiments of the systems disclosed above. The computer system (system 600) includes one or more processors 602-606. Processors 602-606 may include one or more internal levels of cache (not shown) and a bus controller or bus interface unit to direct interaction with the processor bus 612. Processor bus 612, also known as the host bus or the front side bus, may be used to couple the processors 602-606 with the system interface 614. System interface 614 may be connected to the processor bus 612 to interface other components of the system 600 with the processor bus 612. For example, system interface 614 may include a memory controller 618 for interfacing a main memory 616 with the processor bus 612. The main memory 616 typically includes one or more memory cards and a control circuit (not shown). System interface 614 may also include an input/output (I/O) interface 620 to interface one or more I/O bridges or I/O devices with the processor bus 612. One or more I/O controllers and/or I/O devices may be connected with the I/O bus 626, such as I/O controller 628 and I/O device 630, as illustrated. The system interface 614 may further include a bus controller 622 to interact with processor bus 612 and/or I/O bus 626.

I/O device 630 may also include an input device (not shown), such as an alphanumeric input device, including alphanumeric and other keys for communicating information and/or command selections to the processors 602-606. Another type of user input device includes cursor control, such as a mouse, a trackball, or cursor direction keys for communicating direction information and command selections to the processors 602-606 and for controlling cursor movement on the display device.

System 600 may include a dynamic storage device, referred to as main memory 616, or a random access memory (RAM) or other computer-readable devices coupled to the processor bus 612 for storing information and instructions to be executed by the processors 602-606. Main memory 616 also may be used for storing temporary variables or other intermediate information during execution of instructions by the processors 602-606. System 600 may include a read only memory (ROM) and/or other static storage device coupled to the processor bus 612 for storing static information and instructions for the processors 602-606. The system set forth in FIG. 6 is but one possible example of a computer system that may employ or be configured in accordance with aspects of the present disclosure.

According to one embodiment, the above techniques may be performed by computer system 600 in response to processor 604 executing one or more sequences of one or more instructions contained in main memory 616. These instructions may be read into main memory 616 from another machine-readable medium, such as a storage device. Execution of the sequences of instructions contained in main memory 616 may cause processors 602-606 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media. Non-volatile media includes optical or magnetic disks. Volatile media includes dynamic memory, such as main memory 616. Common forms of machine-readable medium may include, but is not limited to, magnetic storage medium; optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

The description above includes example systems, methods, techniques, instruction sequences, and/or computer program products that embody techniques of the present disclosure. However, it is understood that the described disclosure may be practiced without these specific details. In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages should be understood by the foregoing description, and it should be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it should be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

We claim:

1. A system for determining opportunities and tracking a project lifecycle, the system comprising:
one or more processors; and
a memory storing instructions that, when executed by the one or more processors, cause the one or more processors to:
access information for a project offering, the information comprising a customer identification and network service capability;
receive input to modify the information for the project offering;
update the information for the project offering according to the input;
generate, based on the updated information, one of a deadline or a reminder associated with the project offering; and
generate, for display, a lifecycle track of the project offering, the lifecycle track comprising a visual progression of the information based in part on one of the deadline or the reminder.

2. The system of claim 1, wherein the instructions further cause the one or more processors to identify an opportunity for the project offering, the opportunity based on the network service capability and comprising one of a capability of moving the customer from a first network connection provider to a second network provider or a capability for a change in service.

3. The system of claim 2, wherein the instructions further cause the one or more processors to identify opportunities for selling the project offering based on one of environment network changes, pricing adjustments, new service offerings, or the network service capability.

4. The system of claim 1, wherein the input to modify the information for the product offering comprises an indication of one of that the customer has been contacted, the customer has agreed to the project offering, the project offering has changed in status, or the project offering has completed.

5. The system of claim 1, wherein the visual progression comprises a checklist of temporally ordered project milestones.

6. The system of claim 1, wherein the instructions further cause the one or more processors to display the information for the project offering in a tabbed spreadsheet management dashboard.

7. The system of claim 1, wherein the information for the project offering further comprises one of an exchange company circuit (ECCKT) ID, a building status, a building capability, or a project location.

8. A method for determining opportunities and tracking a project lifecycle, the method comprising:
accessing information for a project offering, the information comprising a customer identification and network service capability;
receiving input to modify the information for the project offering;
updating the information for the project offering according to the input;
generating, based on the updated information, one of a deadline or a reminder associated with the project offering; and
generating, for display, a lifecycle track of the project offering, the lifecycle track comprising a visual progression of the information based in part on one of the deadline or the reminder.

9. The method of claim 8, further comprising:
identifying an opportunity for the project offering, the opportunity based on the network service capability and comprising one of a capability of moving the customer from a first network connection provider to a second network provider or a capability for a change in service.

10. The method of claim 9, wherein the instructions further cause the one or more processors to identify opportunities for selling the project offering based on one of environment network changes, pricing adjustments, new service offerings, or the network service capability.

11. The method of claim 8, wherein the input to modify the information for the product offering comprises an indication of one of that the customer has been contacted, the customer has agreed to the project offering, the project offering has changed in status, or the project offering has completed.

12. The method of claim 8, wherein the visual progression comprises a checklist of temporally ordered project milestones.

13. The method of claim 8, the method further comprising:
displaying the information for the project offering in a tabbed spreadsheet management dashboard.

14. The method of claim 8, wherein the information for the project offering further comprises one of an exchange company circuit (ECCKT) ID, a building status, a building capability, or a project location.

15. A non-transitory computer readable medium for determining opportunities and tracking a project lifecycle comprising instructions stored thereon, the instructions effective to cause one or more processors to:
access information for a project offering, the information comprising a customer identification and network service capability;
receive input to modify the information for the project offering;
update the information for the project offering according to the input;
generate, based on the updated information, one of a deadline or a reminder associated with the project offering; and
generate, for display, a lifecycle track of the project offering, the lifecycle track comprising a visual progression of the information based in part on one of the deadline or the reminder.

16. The non-transitory computer readable medium of claim 15, wherein the instructions further cause the one or more processors to identify an opportunity for the project offering, the opportunity based on the network service capability and comprising one of a capability of moving the customer from a first network connection provider to a second network provider or a capability for a change in service.

17. The non-transitory computer readable medium of claim 15, wherein the input to modify the information for the product offering comprises an indication of one of that the customer has been contacted, the customer has agreed to the project offering, the project offering has changed in status, or the project offering has completed.

18. The non-transitory computer readable medium of claim 15, wherein the visual progression comprises a checklist of temporally ordered project milestones.

19. The non-transitory computer readable medium of claim 15, wherein the instructions further cause the one or more processors to display the information for the project offering in a tabbed spreadsheet management dashboard.

20. The non-transitory computer readable medium of claim 15, wherein the instructions further cause the one or more processors to identify opportunities for selling the project offering based on one of environment network changes, pricing adjustments, or new service offerings, and wherein the information for the project offering further comprises one of an exchange company circuit (ECCKT) ID, a building status, a building capability, or a project location.
